(19) United States
(12) Patent Application Publication
(10) Pub. No.: US 2016/0076836 A1
(43) Pub. Date: Mar. 17, 2016

(54) ENHANCED GAS ADJUSTABLE BOLT CARRIER

(71) Applicant: Daniel H. Young, Glendale, AZ (US)

(72) Inventor: Daniel H. Young, Glendale, AZ (US)

(21) Appl. No.: 14/680,129

(22) Filed: Apr. 7, 2015

Related U.S. Application Data
(60) Provisional application No. 62/101,074, filed on Jan. 8, 2015.
(60) Provisional application No. 61/995,325, filed on Apr. 7, 2014.

(51) Int. Cl. F41A 5/24; F16K 31/44; F41A 3/12

(52) U.S. Cl. CPC F41A 5/24; F41A 3/12; F16K 31/44

(57) ABSTRACT

Disclosed is bolt carrier for a firearm wherein the bolt carrier has an adjustable gas flow feature to control the amount of gas used to cycle a bolt carrier group that the bolt carrier is located in. The adjustment of the gas flow can be used to regulate the gas flow as require by changes in ammunition, addition or removal of a sound suppressor, and a desire to alter felt recoil of the firearm. The gas flow feature includes one or more gas adjustment valves that fit into the bolt carrier and that can be used to reliably and rapidly alter the gas flow in a repeatable fashion to cycle the bolt carrier group.

### RELATED APPLICATIONS

This application claims the benefit of U.S. Provisional Application No. 61/995,325 filed on Apr. 7, 2014 and of U.S. Provisional Application No. 62/101,074 filed on Jan. 8, 2015, both of which are hereby incorporated by reference.

### STATEMENT REGARDING FEDERALLY SPONSORED RESEARCH

NONE.

### TECHNICAL FIELD

This invention relates generally to a bolt carrier group in a firearm, and more specifically to a bolt carrier for a firearm that permits adjustment of the gas flow used to cycle the bolt carrier group at a location within the bolt carrier.

### BACKGROUND OF THE INVENTION

Auto-loading firearms are well known in the art and include rifles as well as pistols. These firearms can be designed to operate in a semi-automatic mode and in a fully automatic mode depending on their desired use. During operation of auto-loading firearms like the M-16, M4, AR15 and AR10 pistols or rifles, in the semi-automatic mode so long as there are cartridges in the magazine, a bolt carrier group (BCG) is cycled each time the trigger is pulled. The cycling of the BCG ejects the spent cartridge, cocks the hammer, strips a new cartridge from the magazine, and loads it into the chamber of the firearm. During operation of these firearms in the fully automatic mode the same BCG cycling process occurs so long as there are cartridges in the magazine and the trigger is held in the rearward fire position. The BCG comprises a bolt, a cam pin, a gas key, and a bolt carrier. The bolt further includes a set of gas rings, an extractor, an ejector, and a firing pin. In a typical firearm of this type the cycling of the BCG is accomplished using the gases caused by the burning of the propellant material, gunpowder, from the cartridge in the barrel after the cartridge is fired. Once loaded into the chamber of the firearm the cartridge is initially held in place by the bolt face and a set of lugs on the bolt that interact with lugs in the chamber of the firearm. Down the barrel from the chamber of the firearm is a gas port which is drilled into the top of the barrel at a location prior to the muzzle. The gas port is covered by a gas block which includes a gas channel aligned with the gas port. The gas block also typically includes the front sight for the firearm. The gas channel of the gas block is connected to a gas tube which extends from the gas block back toward the chamber of the firearm and inserts into the gas key when the BCG is fully forward and in battery. The gas key has a gas passage that aligns with a gas hole in the bolt carrier and is in communication with a gas chamber formed by a tail end of the bolt, a set of bolt gas rings, and an internal space in the bolt carrier when the BCG is fully forward in battery.

When the firing pin strikes the primer in the cartridge the gunpowder is ignited. The burning of the propellant expands the cartridge case and forces the lugs on the bolt and in the chamber of the firearm to lock thus sealing that end of the barrel while the projectile begins to move down the barrel propelled by the gases produced from the burning gunpowder. The gases expand and propel the projectile down the barrel toward the muzzle. Once the projectile passes the gas port in the barrel, and while it is still the barrel, the gases sealed between the back of the projectile and the cartridge case flow up through the gas port, through the gas channel in the gas block and into the gas tube. The gases in the gas tube then flow into the gas key, through its gas passage, and into the gas chamber formed by the tail end of the bolt, the set of bolt gas rings, and an internal space in the bolt carrier. When the pressure in the gas chamber reaches a sufficient level the bolt carrier is forced away from the bolt which in turn causes the cam pin to move and rotate the bolt thereby unlocking the bolt lugs from the chamber lugs and unlocking the bolt, which is driven along with the rest of the bolt carrier group back from the chamber of the firearm. This also drives the gas key away from the gas tube as the entire BCG moves backward from the chamber of the firearm and into a buffer tube thereby cocking the hammer and compressing a buffer spring. When the bullet exits the muzzle and the rest of the gases are expelled out of the muzzle. The buffer spring then forces the BCG forward to strip another cartridge from the magazine and load it into the chamber of the firearm thereby reloading the firearm and completing a cycle.

To have reliable feeding of the cartridges into the firearm the manufacturer has to carefully balance barrel length, gas port size and location, gas tube length, and the sizes of the various gas channels, gas passages, and the gas chamber in the gas system. The manufacturer balances all of these factors to provide sufficient dwell time for the gasses and sufficient gas pressure to reliably cycle the BCG. These systems are normally fixed in that the system is not adjustable once the firearm is manufactured. Due to increases in custom cartridge design through handloading, use of subsonic cartridges, use of shorter barrels, and use of sound suppressors there is a desire to be able to adjust the gas flow through the gas system. For example if one adds a sound suppressor to the firearm one is effectively increasing the barrel length and altering the gas dwell time which can cause the BCG to cycle improperly. There is also a desire to reduce recoil, especially in competitive shooting events, by reducing the amount of gas used to cycle the BCG. The use of shorter barrel lengths, which also alters the cycling characteristics, can result in excessive pressure on the BCG and very violent cycling of the action. The main types of BCG issues seen with these alterations include short stroking, failure to extract, and forced extraction. In a short stroking failure the BCG does not cycle for a sufficient amount of time to allow it to strip the next cartridge from the magazine and thus it does not feed a new cartridge into the chamber. In a failure to extract the pressures are too high and the bolt is unable to grip the cartridge sufficiently to extract it after the cartridge is fired and a jam occurs. In a forced extraction the pressures are too high and the BCG attempts to extract the cartridge while the barrel is still pressurized and this can result in the cartridge casing failing leaving a part of the casing in the chamber as a new cartridge is fed into the chamber. All of these issues can be serious problems, especially in combat situations. To address these issues prior solutions have include creating an adjustable gas block installed in place of the regular gas block on the barrel. Typically, rotation of an adjustment screw in the adjustable gas block can be used to adjust the gas flow through the system and the dwell time. These adjustable gas blocks have not been a satisfactory solution as they tend to be cumbersome to use, difficult to tune/adjust, and the adjustments once made can be hard to maintain as the adjustment screw tends to move during use. In addition, they are difficult to rapidly adjust between several settings in a repeatable manner without having to again go through the cumbersome tuning process. These systems also do not let a user look at the system and rapidly tell what the current setting is designed for, use with a sound suppressor, subsonic ammunition, regular cartridge loads etc.

It is desirable to provide an enhanced system for adjusting gas flow in firearms to allow for reliable cycling of the BCG, particularly in AR15, AR10, M16 and M4 type firearms.

### SUMMARY OF THE INVENTION

In general terms, this invention provides a bolt carrier having a gas adjustment system for adjusting the gas used to cycle the BCG. The invention comprises a bolt carrier for a firearm comprising: a gas valve bore that is in communication with a gas hole and a gas chamber formed in part by the bolt carrier; and a gas adjustment valve that is received in the gas valve bore in the bolt carrier and that regulates a flow of gas through the gas hole into the gas chamber to cycle a bolt carrier group. The invention allows for rapid, simple and repeatable adjustments to the gas flow. Embodiments allow a user to rapidly switch between various settings. The user can quickly and visually confirm what the current gas flow setting is thereby reducing possible errors. The gas adjustment valve can be of any shape or form that permits it to regulate flow a flow of a gas from the gas hole into the bolt carrier and specifically into an internal space in the bolt carrier that forms a part of the gas chamber in the bolt carrier.

In one embodiment the present invention is a bolt carrier for a firearm comprising: a bolt carrier having a gas hole, the gas hole in communication with an internal space in the bolt carrier, the internal space forming a portion of a gas chamber; and a gas valve bore having a shape in said bolt carrier, the gas valve bore in communication with the gas hole and the internal space, and the gas valve bore adapted to receive a gas adjustment valve for regulating a flow of a gas from the gas hole into the internal space.

In another embodiment the present invention is a gas adjustment valve for a bolt carrier of a firearm comprising: a shaft and head; the shaft shaped to be received in a bore in a bolt carrier thereby regulating a flow of a gas from a gas hole in the bolt carrier into an internal space in the bolt carrier.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1A is a schematic top view of a gas adjustable bolt carrier in accordance with an embodiment of the present invention;

FIG. 1B is a schematic side view of the bolt carrier shown in FIG. 1A;

FIG. 2 is a schematic close up of detail B from FIG. 1B showing a gas valve bore for insertion of a gas adjustment valve according to an embodiment of the present invention;

FIG. 3 is a schematic of cross-section A-A of FIG. 1B showing the gas valve bore for insertion of the gas adjustment valve;

FIG. 4 is a partial cutaway schematic view of a gas adjustable bolt carrier and a plurality of gas adjustment valves in accordance with an embodiment of the present invention;

FIG. 5 is a partial cutaway schematic view of the embodiment shown in FIG. 4 with a gas adjustment valve inserted into the gas valve bore in accordance with an embodiment of the present invention;

FIG. 6 is a partial cutaway schematic view of a gas adjustable bolt carrier in accordance with an embodiment of the present invention;

FIG. 7 is a partial cutaway schematic view of a gas adjustable bolt carrier in accordance with the embodiment shown in FIG. 6 with a gas adjustment valve shown in the gas valve bore; and

FIG. 8 is a partial cutaway schematic of the view shown in FIG. 7.

### DETAILED DESCRIPTION OF A PREFERRED EMBODIMENT

The present invention is directed toward a bolt carrier having a gas flow adjustment feature to permit a user to adjust the gas flow through the gas system used to cycle the bolt carrier group (BCG) during operation of the firearm. The invention allows for repeatable, rapid, and reliable adjustment of the gas flow into a gas chamber in the BCG to cycle the BCG during operation of the firearm. It finds special use in direct impingement gas systems of firearms. The invention resides in forming a bore in the bolt carrier with the bore in communication with a gas hole in the bolt carrier and with an internal space in the bolt carrier that forms a part of the gas chamber found in the bolt carrier group and a gas adjustment valve adapted to be received in the bore, the gas adjustment valve for regulating flow of a gas from the gas hole into the internal space of the bolt carrier. The valve is not limited to a particular shape so long at it can be received in the bore and regulate the flow of a gas from the gas hole into the internal space.

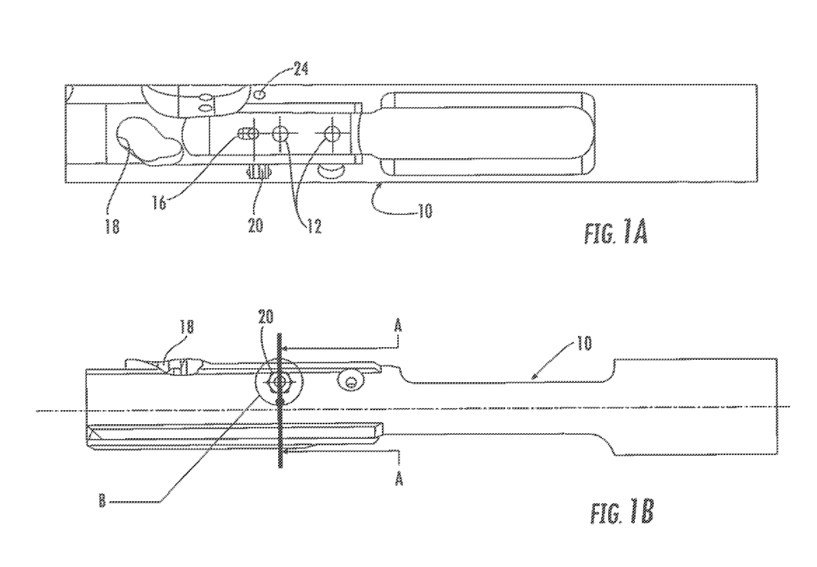

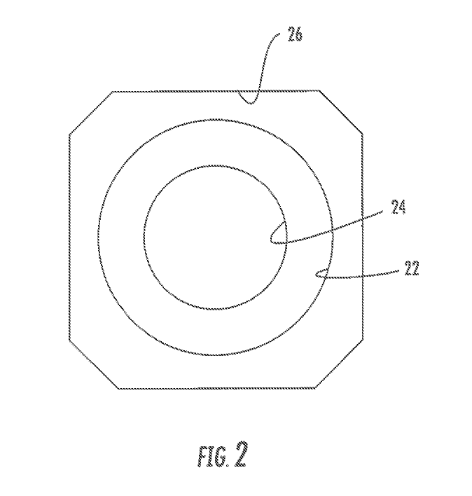

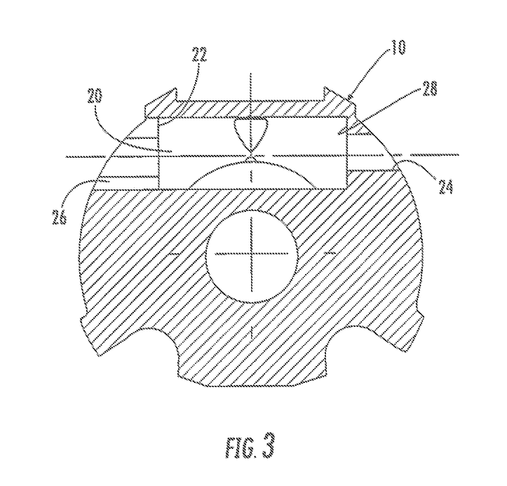

An embodiment of the gas adjustable bolt carrier invention is shown in FIG. 1A through FIG. 5. FIG. 1A shows a top view of a bolt carrier 10 of a BCG. The bolt carrier 10 is shown without a bolt inserted into the bolt carrier 10 and without a gas key attached to the top of the bolt carrier 10. The bolt carrier 10 includes a pair of screw holes 12 used to secure the gas key, not shown, to the bolt carrier 10. Adjacent to one of the screw holes 12 is a gas hole 16 in the top of the bolt carrier 10. The gas hole 16 aligns with a gas channel in the gas key when the gas key is secured to the bolt carrier 10 using the screw holes 12. The gas hole 16 is in communication with a gas chamber, not shown, formed by a tail end of the bolt, a set of bolt gas rings, and an internal space 54 in the bolt carrier 10. The gas chamber formed in the bolt carrier is known to those of skill in the art. In the present specification and claims the term gas chamber is meant to refer to this gas chamber unless noted otherwise. A cam pin hole 18 accommodates a cam pin, not shown, and together they function to lock and unlock the lugs on the bolt and in the chamber of the firearm during cycling of the BCG. A gas valve bore 20 having a first end 22 and a second end 24 extends through the bolt carrier 10 and is in communication with the gas hole 16. The gas valve bore 20 allows for insertion of a gas adjustment valve 40 in accordance with the present invention. The gas valve bore 20 is aligned with the gas hole 16. FIG. 1B is a side view of the bolt carrier 10 shown in FIG. 1A and shows the location of gas valve bore 20 and the locations of detail B and cross-section A-A shown in FIGS. 2 and 3, respectively. FIG. 2 shows that preferably gas valve bore 20 at the first end 22 is surrounded by a shaped opening 26. The shape of the shaped opening 26 is designed to match with a shaped end 48 on the gas adjustment valve 40. The purpose of the shaped opening 26 matching with the shaped end 48 is to prevent rotation of the gas adjustment valve 40 in the gas valve bore 20. The shaped opening 26 and shaped end 48 can have any matched contour that prevents rotation of the gas adjustment valve 40 once it is inserted into the gas valve bore 20. Alternatively, the gas valve bore 20 and the gas adjustment valve 40 could have matching contours that prevent rotation of the gas adjustment valve 40 in the gas valve bore 20. For example, gas valve bore 20 could be machined to have a square cross-sectional shape as could a portion of the gas adjustment valve 40 such that when the gas adjustment valve 40 is inserted into the gas valve bore 20 the gas adjustment valve 40 cannot rotate. Cross-section A-A of FIG. 1B is shown in FIG. 3. The gas valve bore 20 preferably has a shoulder stop 28 adjacent the second end 24 of the gas valve bore 20. The shoulder stop 28 is formed when a diameter of the first end 22 of the bore 20 is larger than a diameter of the second end 24 of the bore 20. In such an embodiment, when the gas adjustment valve 40 is fully received in the gas valve bore 20 an end of the gas adjustment valve 40 rests against shoulder stop 28. Alternatively, the bore 20 could have a constant diameter throughout.

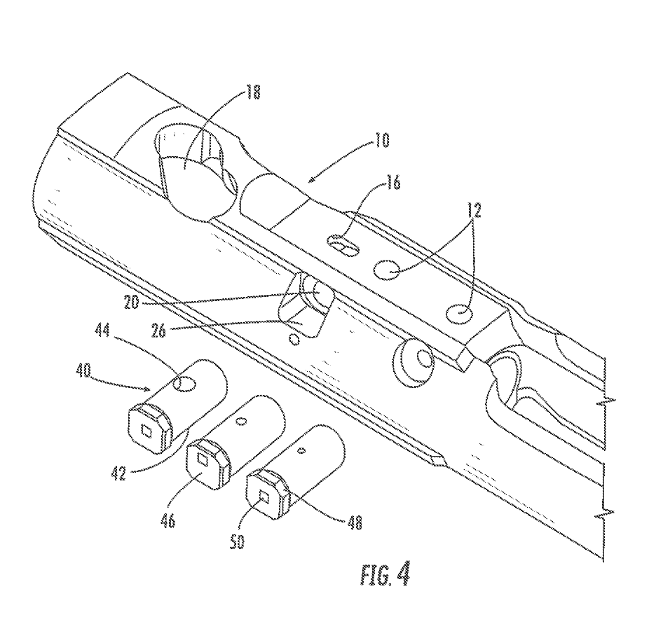

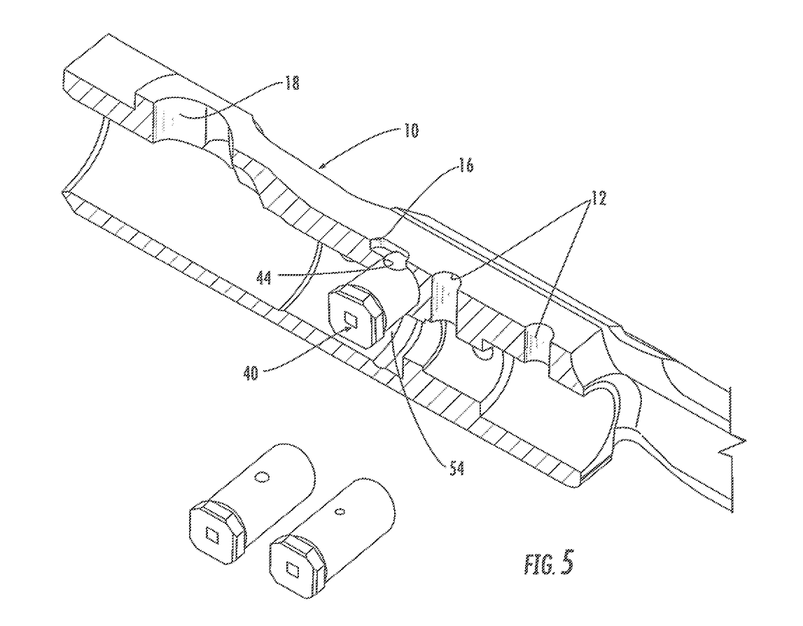

FIG. 4 shows a side view of a schematic view of a gas adjustable bolt carrier 10 and a plurality of gas adjustment valves 40 in accordance with an embodiment of the present invention. Each valve 40 has a shaft 42 and a gas hole 44 that passes through it. One end of the valve 40 has a head 46 having a shaped end 48, the diameter of the head 46 is larger than the diameter of the first end 22 of the bore 20. As discussed above, when the gas adjustment valve 40 is inserted into gas valve bore 20 the shape of the shaped end 48 matches with the shaped opening 26 to prevent rotation of the valve 40 in the bore 20. Any matching shapes can be used for the shaped end 48 and shaped opening 26 provided they prevent rotation of the valve 40 in the bore 20. The gas hole 44 aligns with the gas hole 16 in the bolt carrier 10 when the gas adjustment valve 40 is fully inserted into gas valve bore 20. As shown, a plurality of gas adjustment valves 40 each of which has a gas hole 44 having a different diameter, can be used to adjust the amount of gas allowed to flow from the gas hole 16 into the gas chamber to control cycling of the BCG. Preferably, the largest diameter gas hole 44 is sized to permit the amount of gas through the gas hole 16 as is set when the firearm is manufactured. Thus, this valve 40 would be design to function with standard ammunition and no modifications to the gas system or barrel length such as by attachment of a suppressor. Additional gas adjustment valves 40 having gas holes 44 with different diameters can be used to vary the gas flow through the gas hole 16, generally by restricting flow. The gas adjustment valves 40 can be removed from the bore 20 by pushing against the valve 40 through the second end 24 of the bore 20. Thus, one can rapidly and reliably alter the gas flow in a readily reproducible manner using a series of gas adjustment valves 40. The valves 40 can include an index symbol 50 of any sort to allow for a user to distinguish between the valves 40. Preferably the index symbol 50 can be perceived in a tactile sense, for example by being a raised design, allowing for identification of each valve 40 even in the dark. Any number of valves 40 can be used in the system to allow for nearly infinite variation of the gas flow. As discussed above, alternatively shaft 42 and bore 20 could be shaped to match with each other, shaped in a non-round shape, such that when valve 40 is inserted into bore 20 the valve 40 cannot rotate. As shown in FIG. 5, when the gas adjustment valve 40 is inserted into bore 20 gas hole 44 aligns with gas hole 16 in bolt carrier 10. The gas holes 16 and 44 are in communication with the gas chamber, formed by the tail end of the bolt, a set of bolt gas rings, and an internal space, a portion of which is shown at 54, in the bolt carrier 10. Using the gas adjustment valves 40 with different diameter gas holes 44 allows one to reliably and quickly change the gas flow used to cycle the BCG in a very repeatable fashion and thereby to adjust for changes in ammunition, use of sound suppressors, and to reduce felt recoil. The shaped opening 26 and matching shaped end 48 ensure the gas adjustment valve 40 does not rotate in bore 20.

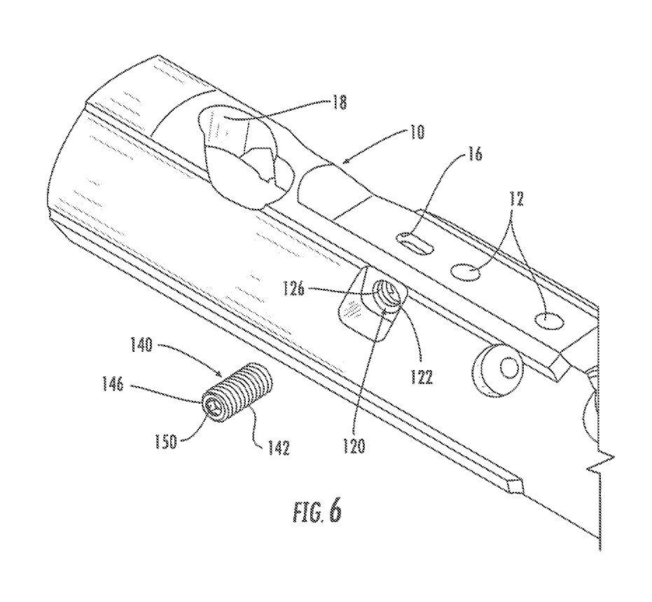

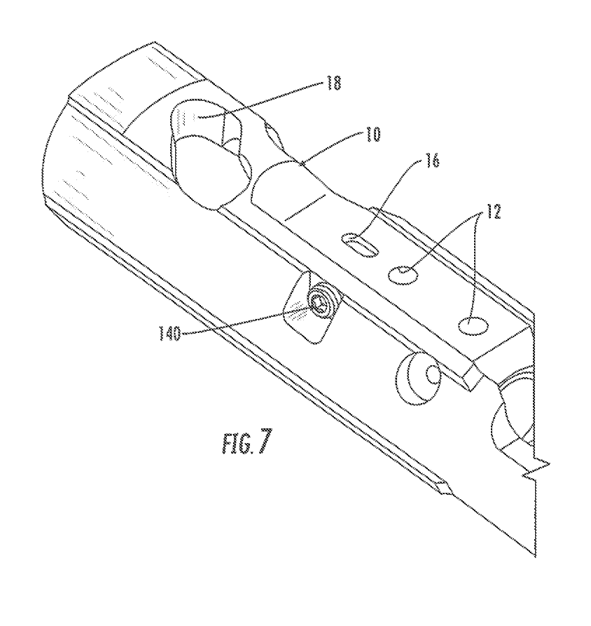

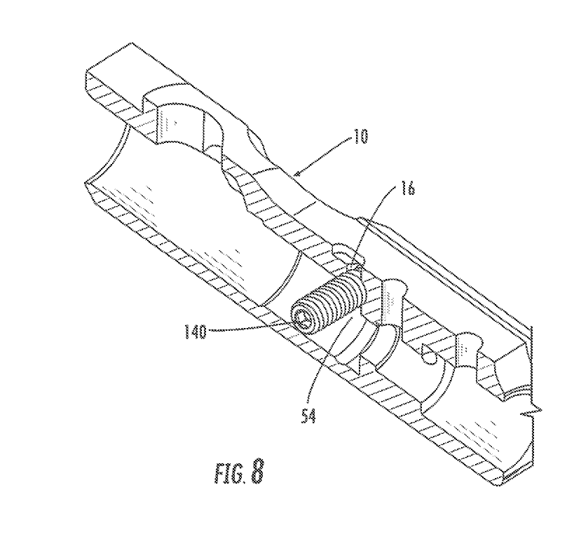

FIG. 6 is a schematic view of a gas adjustable bolt carrier 10 in accordance with an embodiment of the present invention. In this embodiment, the bolt carrier 10 is shown without the bolt inserted into the bolt carrier 10 and without the gas key attached to the top of the bolt carrier 110. The bolt carrier 10 includes the pair of screw holes 12 used to secure the gas key, not shown, to the bolt carrier 10. Adjacent to one of the screw holes 12 is the gas hole 16 in the top of the bolt carrier 10. The gas hole 16 aligns with a gas channel in the gas key when the gas key is secured to the bolt carrier 10 using the screw holes 12. The gas hole 16 is in communication with a gas chamber, not shown, formed by the tail end of the bolt, a set of bolt gas rings, and an internal space 54 in the bolt carrier 10. Also shown is the cam pin hole 18 which accommodates a cam pin, not shown, and which functions to lock and unlock the lugs on the bolt and in the chamber of the firearm during cycling of the BCG. A gas valve bore 120 allows for insertion of a gas adjustment valve 140 in accordance with the present invention. The bore 120 is aligned with the gas hole 16 and has a first end 122. In this embodiment, the bore 120 does not have to pass completely through the bolt carrier 10, but it can if desired. The bore 120 includes a set of threads 126. The gas adjustment valve 140 has a threaded shaft 142 that mates with the threads 126 in the bore 120. The gas adjustment valve 140 has a head 146 that includes a feature allowing the valve 140 to be rotated into bore 120. In the embodiment shown, the feature as shown is a hex screw head 150 designed to receive a hex key as known in the art, although other head designs can be used such as, by way of example, a slot or slots for receiving a flat screwdriver or a Phillips head screwdriver, it can be designed as a star shaped screw head such as a Torx® shape, or as a hexagonal bolt head as understood by one of skill in the art. FIG. 7 is a schematic view of the gas adjustable bolt carrier 10 with the gas adjustment valve 140 shown in the gas valve bore 120. FIG. 8 is a partial cutaway schematic of the view shown in FIG. 7. As shown as the gas adjustment valve 140 is screwed into bore 120 it reduces the flow of gas through gas hole 16 and thereby adjusts the gas flow into the gas chamber, not shown, formed by the tail end of the bolt, the set of bolt gas rings, and an internal space 54 in the bolt carrier 10. Thus the position of the shaft 142 of the gas valve 140 in the bore 120 allows one to adjust the gas flow used to cycle the BCG. In this embodiment the gas flow is infinitely adjustable from the maximal flow allowed by the manufactured design to, theoretically, complete closure of flow through the gas hole 16. In practice complete closure would prevent the BCG from cycling, thus one can adjust the length of the shaft 142 of the valve 140 to prevent complete closure. Alternatively, the head 150 can have a larger diameter than the diameter of bore 120 in conjunction with an appropriate length of the shaft 142 to prevent over reduction of the gas flow through the gas hole 16. In this cutaway view, FIG. 8, one can see a portion of the internal space 54 of the bolt carrier 10 that forms the gas chamber, this was not visible in the other figures, but is present in all bolt carriers as known to those of skill in the art.

The particular gas adjustment valves shown are examples of suitable gas adjustment valves, other designs for the gas adjustment valve could be utilized provided they are capable of regulating flow of a gas from the gas hole in the bolt carrier into the gas chamber formed in the bolt carrier group.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A bolt carrier for a firearm comprising:
a bolt carrier having a gas hole, said gas hole in communication with an internal space in said bolt carrier, said internal space forming a portion of a gas chamber; and
a gas valve bore in said bolt carrier, said gas valve bore in communication with said gas hole and said internal space, and said gas valve bore adapted to receive a gas adjustment valve for regulating a flow of a gas from said gas hole into said internal space.

2. The bolt carrier as recited in claim 1 further comprising a gas adjustment valve, said gas adjustment received in said bore, and said gas adjustment valve regulating a flow of a gas from said gas hole in said bolt carrier into said internal space.

3. The bolt carrier as recited in claim 2, wherein said gas adjustment valve has a shaft with said shaft being received in said bore.

4. The bolt carrier as recited in claim 3, wherein said shaft has a shape matching a shape of said bore and said shape of said shaft and said shape of said bore prevent rotation of said shaft in said bore.

5. The bolt carrier as recited in claim 1, wherein said gas valve bore passes through said bolt carrier, said bore having a first end and a second end.

6. The bolt carrier as recited in claim 5, wherein said first end has a first diameter and said second end has a second diameter, with said second diameter being smaller than said first diameter, and said bore further comprising a shoulder stop in said bore, said shoulder stop located adjacent said second end.

7. The bolt carrier as recited in claim 5, further comprising a shaped opening, said shaped opening located adjacent said first end.

8. The bolt carrier as recited in claim 7, further comprising a gas adjustment valve, said valve having a shaft, a head and a shaped end;
said shaft including a gas hole passing through said shaft, said shaft received into said bore, said gas hole in said shaft aligned with said gas hole in said bolt carrier;
said shaped end matching with said shaped opening and thereby preventing said valve from rotating in said bore when said shaped end is received in said shaped opening; and
said gas hole in said shaft regulating a flow of a gas from said gas hole of said bolt carrier into said internal space.

9. The bolt carrier as recited in claim 8, wherein said head has a diameter that is larger than a diameter of said bore, said diameter of said head preventing said valve from passing completely through said bore.

10. The bolt carrier as recited in claim 1, wherein said bore is threaded.

11. The bolt carrier as recited in claim 10, further comprising a gas adjustment valve, said valve having a threaded shaft and a head;
said threaded shaft received into said threaded bore; and
said shaft in said bore regulating a flow of a gas from said gas hole of said bolt carrier into said internal space.

12. The bolt carrier as recited in claim 11, wherein said head of said valve is in the shape of one of a hex screw head, a slot, a plurality of slots, a star shaped screw head, or a hexagonal bolt head.

13. The bolt carrier as recited in claim 11, wherein said head has a diameter that is larger than a diameter of said bore.

14. A gas adjustment valve for a bolt carrier of a firearm comprising:
a shaft;
said shaft shaped to be received in a bore in a bolt carrier thereby regulating a flow of a gas from a gas hole in said bolt carrier into an internal space in said bolt carrier.

15. The gas adjustment valve as recited in claim 14, wherein said shaft is threaded.

16. The gas adjustment valve as recited in claim 14, where said shaft has a gas hole through said shaft, a diameter of said gas hole regulating a flow of a gas from a gas hole in said bolt carrier into an internal space in said bolt carrier.

17. The gas adjustment valve as recited in claim 14, wherein said valve has a head and said head has a shaped end.

18. The gas adjustment valve as recited in claim 17, wherein said head includes an index symbol, said index symbol related to said diameter of said gas hole in said shaft.

19. The gas adjustment valve as recited in claim 17, wherein said shaped end prevents rotation of said shaft in said bore of said bolt carrier.

20. The gas adjustment valve as recited in claim 17 wherein said head of said valve is in the shape of one of a hex screw head, a slot, a plurality of slots, a star shaped screw head, or a hexagonal bolt head.
